(19) United States
(12) Patent Application Publication
(10) Pub. No.: US 2006/0029701 A1
(43) Pub. Date: Feb. 9, 2006

(54) System and process for producing animal feed from food waste

(76) Inventor: William H. Moss, Coral Springs, FL (US)

Correspondence Address: DUANE MORRIS, LLP;IP DEPARTMENT, 30 SOUTH 17TH STREET, PHILADELPHIA, PA, 19103-4196, US

(21) Appl. No.: 10/910,139

(22) Filed: Aug. 3, 2004

(51) Int. Cl. A23L 1/00; A23B 4/03

(52) U.S. Cl. 426/454; 426/285

(57) ABSTRACT

A method for manufacturing a dehydrated food waste product including a dry additive of recycled, dried food pellets and utilizing a mixer and pelletizer is disclosed, which includes maintaining a distance of less than about one meter between mixer and pelletizer.

### FIELD OF THE INVENTION

The present invention relates to methods of producing animal feed from food waste without the addition of other dry materials.

### BACKGROUND OF THE INVENTION

Myer et. al., in “Dehydrated Restaurant Food Waste as Swine Feed,” evaluated restaurant Dehydrated Food Waste (DFW) from restaurants as a potential feedstuff for finishing pigs. The final DFW product used in this study was 60% DFW (dry matter basis). The balance was a mixture of soy hulls and ground corn. The dry soy hulls and ground corn were used as absorbents to reduce the moisture of the raw food waste. The moisture of the raw food waste was too high for processing and had to be reduced prior to pelletizing and drying. The moisture of the raw food waste was reduced from 75-77% to 40% for the mixture of food waste, soy hulls and corn. The process to produce DFW pellet(s) was that as described by Rice and Long (U.S. Pat. No. 5,596,815). Pigs fed diets containing 60% DFW in the Myer trials had average daily growth rates that were similar to pigs fed a standard growing/finishing diet for swine. Average weight of feed per unit weight gain for pigs fed diets containing 60% DFW were superior to the weight of feed per unit weight gain for pigs fed standard diets, i.e., less feed required for the same weight gain. Scientific measurements of the meat showed no difference between pigs fed control diets and pigs fed diets containing DFW.

Walker, in “The Use of Food Waste as a Feedstuff for Ruminants,” evaluated Pulped Food Waste (PFW) as a potential feedstuff for beef cattle. Raw food waste was collected and then pulped in a wet grinder, mixed with other animal feed ingredients, and dry-extruded to produce an animal feed. PFW was mixed with soybean hulls and ground corn at a ratio of 40:55:5. The addition of soy hulls and ground corn made the PFW more suitable for extruding. Moisture content of PFW was 54%. After mixing, the pre-extrusion moisture of the PFW and Soybean Hulls and Ground Corn mixture was 37%, and the post-extrusion moisture was 31%. The dry-extrusion process utilizes friction and pressure to generate heat. Product internal temperatures in the extrusion process reached 140-160° C. Extrusion pressures prior to discharge through an expansion die reached 2,700 psig. The calculated dried food waste in the final product was 32% PFW (dry matter basis). Walker did theoretical calculations to assess the viability of the extruded PFW for animal feeds. The calculations suggested that dry-extruded PFW came close to meeting the dietary requirements for ruminants. Palatability trials with sheep, lambs and beef cattle indicated that diets containing dry-extruded PFW were acceptable.

Walker reported that several attempts were made to use horizontal presses to dewater pulped food waste. Regardless of adjustments to the press, the press would not process the pulped food waste. Therefore, pulped food waste was blended with several other raw materials capable of absorbing moisture before extruding. The maximum food waste content (dry matter basis) of the dry-extruded PFW produced by Walker was 31%.

Myer et. al., in “Evaluation of Dehydrated Restaurant Food Waste Products as Feedstuffs for Finishing Pigs,” blended food waste with dry additives such that the resulting blend had moisture of 40%. The moisture of the food waste and dry additives mixture had to be reduced to 40% in order to form strands that held their shape after low-pressure extrusion (100-150 psig). The fluid bed dryer required uniform strands to properly dry the incoming product. After pelletizing and drying, the DFW content of the final product was 25% (dry matter basis). Final product can be “recycled” as a dry additive to increase the concentration of DFW in the final product to 60% (dry matter basis). The final products used in the pig feeding trials contained 60% DFW. Myer was unable to increase the DFW content above 60%. While recycling final product can increase the DFW content, it increases the likelihood that nutrients will be destroyed by increased exposure to high dryer temperatures (150-200° C.). In addition, the final product may be over-dried, making the feed ingredient less palatable to pigs. Based on the above, the recycling ratio of recycled final product-to-raw food waste was 0.6:1, and the average number of times a food waste pellet (raw and recycled food waste) passed through the dryer was 3.13 times.

An object of the present invention is the establishment of methods for producing material derived from dewatering and drying food waste, without the addition of other dry materials.

### SUMMARY OF THE INVENTION

The present invention relates to a method for manufacturing a dehydrated food waste product including a dry additive of recycled, dried food pellets and utilizing a mixer and pelletizer, which comprises maintaining a distance of less than about one meter between mixer and pelletizer. In a preferred embodiment, the present invention discloses a material derived from dewatering and drying food waste without any addition of other dry materials, i.e., 100% DFW.

Additionally, the present invention relates to the production of 100% DFW with a moisture content of less than 12%. Dry animal feed ingredients should have moistures below about 12% to prevent mold and other bacteria-based decomposition. If the moisture of dry animal feed ingredients is reduced below 12%, they may be safely stored for six months, or longer.

### DETAILED DESCRIPTION OF THE INVENTION

Whereas prior art methods were unable to extrude mixtures of food waste and dry additives with moisture contents above about 40%, the present invention serves to successfully extrude mixtures of food waste and recycled, dry food waste with moisture contents of about 50-60%. In accordance with the present invention, a pelletizer, such as that described in U.S. Pat. No. 6,099,288, herein incorporated by reference, is employed so as to extrude higher moisture mixtures.

Mixtures of food waste and recycled, dried food waste moisture content above 40% are very sticky, making it difficult to transfer material from the mixer to the pelletizer with conventional material transfer equipment. A key design feature is to have a direct connection with the shortest distance possible between mixer and pelletizer to prevent sticking.

In order to start the process, some type of material other than recycled, dried food waste is needed to make the initial batches. At least two batches of DFW containing foreign material such as soy hulls, rice bran, wheat midds or ground corn are needed to start up the process. After the two initial batches, subsequent batches should only use recycled, dried food waste as the dry additive.

A special measurement is needed to confirm that the final product is 100% DFW. Since the salt concentration of food waste on a dry matter basis is about 10-100 times greater than the salt concentration in the foreign materials added, the salt concentration is an effective indicator. The salt concentration (measured as % NaCl on a dry matter basis) of the final DFW product should approach the salt concentration (measured as % NaCl on a dry matter basis) of raw food waste. It will take approximately 20 batches for the salt concentration of the DFW to approach 99+% of the salt concentration of the raw food waste.

In accordance with the present invention, the resulting DFW had the following characteristics: 1) The only additive is recycled, DFW; 2) The moisture of the mixture of food waste plus recycled DFW to the pelletizer is about 50-60%; 3) The ratio of recycled DFW to food waste is about 0.4-0.5; and 4) The mean residence time of food waste material in the dryer is about 3-3.5 times the average detention time.

The results with animal feed diets containing 100% DFW (demonstrating superior nutritional characteristics) are shown in Table I, below. The nutritional composition of a traditional corn/soybean meal diet consisting of two parts corn and one part soybean meal is compared to 60% DFW processed from Orlando, Fla. Theme Park food waste and 100% DFW processed from Seongnam, South Korea municipal food waste.

TABLE I
Comparison of the nutritional characteristics of DFW and corn/soybean meal diets

| | | | 67% Corn | 60% DFW | |
|---|---|---|---|---|---|
| | | Soybean | 33% Soybean | 40% (Soy hulls + | |
| | Corn | Meal | Meal | wheat midds) | 100% DFW |
| Food Waste Source | | | | Orlando | Seongnam, |
| | | | | Theme Parks | South Korea |
| Moisture | 13.0 | 12.0 | 12.7 | 7.9 | 10.0 |
| Crude protein | 7.9 | 47.8 | 21.2 | 22.4 | 22.8 |
| Crude fat | 3.5 | 1.0 | 2.7 | 23.2 | 8.9 |
| Crude fiber | 1.9 | 3.0 | 2.3 | 2.3 | 10.6 |
| Total mineral matter | 1.1 | 6.0 | 2.7 | 5.4 | 19.3 |
| (ash) | | | | | |
| Calcium | 0.1 | 0.2 | 0.1 | 0.5 | 2.4 |
| Phosphorus | 0.3 | 0.7 | 0.4 | 0.5 | 0.5 |
| Sodium | 0.02 | 0.04 | 0.0 | 0.9 | |
| Chloride | 0.04 | 0.02 | 0.0 | 0.4 | |
| NaCl | 0.06 | 0.06 | 0.1 | 1.3 | 1.00 |
| Potassium | 0.3 | 1.9 | 0.8 | 0.7 | |
| Lysine, g/100 g | 0.24 | 3.02 | 1.17 | 0.53 | 1.39 |
| Metabolizable Energy, | 3,350 | 3,140 | 3,280 | 3,300 | 3,844 |
| Kcal/kg | | | | | |

DFW diets were comparable to traditional corn/soybean meal diets in crude protein. DFW diets were superior in fat, crude fiber and metabolizable energy. The 100% DFW product was superior in nutritional value to the 60% DFW product (higher fiber, higher lysine). Furthermore, the present invention results in more efficient feeding (lower units of feed per unit weight gain), as shown in Table II, below).

TABLE II
Performance of pigs fed diets containing DFW

| | Control | Myer et. al. | | Myer et. al. | |
|---|---|---|---|---|---|
| | Diet | 60% DFW | 100% DFW | 60% DFW | 100% DFW |
| Feed Mixture | | | | | |
| DFW | 0% | 40% | 40% | 80% | 60% |
| Traditional Feed | 100% | 60% | 60% | 20% | 40% |
| % DFW in total diet | 0% | 24% | 40% | 48% | 50% |
| Weight Gain Efficiency | 3.27 | 3.17 | 3.02 | 2.98 | 2.90 |
| Feed/Unit Gain (kg/kg) | | | | | |
| Relative Ratio | 1.0000 | 0.9694 | 0.9235 | 0.9113 | 0.8869 |
| Savings, % | — | 3.06% | 7.65% | 8.87% | 11.31% |

Pigs fed DFW diets required, on average, less feed per unit of weight gain than pigs fed the control diet. The higher the % DFW in the total diet, the more efficient the weight gain (less feed per unit weight gain). 100% DFW pellets enabled higher percent DFW in total pig diets than 60% DFW. Therefore, using 100% DFW in pig feed diets will result in more efficient feeding. It is theorized that the better feed-to-gain is due to the higher fat content and higher fraction of saturated fats in DFW diets. According to Myer et. al., the acid profile of DFW is more desirable than that obtained fat contained in conventional animal feed.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What is claimed is:

1. A method for manufacturing a dehydrated food waste product including a dry additive of recycled, dried food pellets and utilizing a mixer and pelletizer, which comprises maintaining a distance of less than about one meter between mixer and pelletizer.

2. The method as recited in claim 1, wherein the recycle rate of recycled, dried food pellets is from about 0.4-0.5 times the rate of pretreated raw food waste.

3. The method as recited in claim 1, wherein the average residence time of a food pellet in a dryer is about 3-3.5 times the average detention time of material passing through the dryer.

4. The method as recited in claim 1, wherein the moisture content of the mixture of food waste and recycled, dried food waste is greater than about 40%.

5. The method as recited in claim 1, wherein the shortest possible distance between mixer and pelletizer is established so as to prevent sticking.

6. The method as recited in claim 1, wherein the dehydrated food waste product contains about 100% dehydrated food waste.

7. The method as recited in claim 1, wherein the dehydrated food waste product contains about 61-99% dehydrated food waste.

8. The method as recited in claim 1, wherein the dehydrated food waste product has a moisture content less than or equal to about 12% moisture

9. The method as recited in claim 1, wherein dry materials are added as needed to adjust moisture content.
